(19) United States
(12) Patent Application Publication
(10) Pub. No.: US 2009/0257438 A1
(43) Pub. Date: Oct. 15, 2009

(54) METHOD AND SYSTEM FOR TRANSPORT OF STRUCTURE AWARE TDM TRAFFIC OVER PACKET NETWORKS

(76) Inventors: Timothy D. Wright, Dallas, TX (US); Mark Sanders, Roanoke, VA (US); Steven Scully, Bensenville, IL (US)

Correspondence Address: WINSTEAD PC, P.O. BOX 50784, DALLAS, TX, 75201, US

(21) Appl. No.: 12/401,560

(22) Filed: Mar. 10, 2009

Related U.S. Application Data
(60) Provisional application No. 61/035,267, filed on Mar. 10, 2008.

(51) Int. Cl. H04L 12/56

(52) U.S. Cl. 370/401

(57) ABSTRACT

A communications network gateway receives a stream of information formatted to be compatible with a synchronous structured network. The frames from the synchronous structured network are extracted and modified for transmission over a packet network in a manner that optimizes bandwidth utilization of the overall communications network.

### RELATED APPLICATIONS

This application claims priority to and incorporates by reference the entirety of U.S. Provisional Application Ser. No. 61/035,267 filed Mar. 10, 2008.

### TECHNICAL FIELD

This application relates generally to communication networks and more particularly, but not by way of limitation, to methods and systems for utilizing packet networks to transport TDM based traffic.

### BACKGROUND

Information in today's networks is transported over various media such as Time Division Multiplexing (TDM), Asynchronous Transport Network (ATM), and Packet Networks. The trend in information transportation is moving towards Packet Networks; however, TDM traffic operates in a synchronous manner and needs to be converted from a synchronous constant rate format to an asynchronous format for packet network transport.

Encapsulation of traffic from TDM networks into packets can be accomplished through the use of structure aware TDM pseudowire techniques which packetize structured (NxDS0) TDM signals as packets for transport over Packet Switched Networks. This encapsulation technique is inefficient in that any of the structured DS0 circuit in a TDM signal can transmit idle (non-information carrying) information that is intermixed with active information carrying DS0 circuits.

Many mobile cellular networks and fixed wireline networks employ standard based methods for transporting voice, video, data, and signaling information that rely on the structured (NxDS0) circuits to transmit over the network. As these are translated into a packet infrastructure the idle information along with the actual data information is transmitted over the network resulting in inefficient use of the bandwidth due the transmission of both idle and data traffic. An example of such a network is shown in FIG. 1. In the event that the TDM traffic contains mainly idle information, this technique will continue to transmit the packet information for each bit of information received from the TDM circuit connection. While this method does create a packetized stream of traffic, it unnecessarily wastes bandwidth in the packet network. This waste of bandwidth results in the need to purchase additional bandwidth capacity to transmit information.

Since many mobile cellular networks and fixed wireline networks transport infrastructure allow for a fixed bandwidth pipe for the transmission of the information stream, the transmission of idle information is inefficient and wastes bandwidth that can be used for delivery of other services. TDM technology was developed to transmit digital voice and signaling information over fixed wireline networks. The mobile carrier networks use TDM circuits to transport information from the wireless networks to the mobile infrastructure. The inherent nature of digitized voice traffic in these networks is a constant rate of transmission. This constant rate of transmission contains both bearer voice traffic and idle information to maintain the information transmit flow.

As data bearing applications that utilize asynchronous operations (such as data service applications that access the internet) are transported over TDM network infrastructure, additional idle information is transmitted. This idle information will be transmitted in any encapsulated packet transmission along with the actual information, thus reducing the efficiency of the packet.

Many packet networks utilize fixed allocations of bandwidth that are used for all the information that is to be transmitted. The access to these packet networks is through gateways that perform translation of information into a common format for transmission and that also must limit the transmission of the data into the fixed bandwidth pipe, applying limits to the amount of information that can be transmitted as shown in FIG. 2. The addition of the idle transmission inside of the packets will limit the amount of true information that can be transmitted over the fixed information pipe.

Therefore, there is a need for a system and method to efficiently utilize the available bandwidth pipe to transmit TDM information over a packet network.

### SUMMARY

Various embodiments include a method for efficiently transporting the structure aware and for efficiently utilizing the network bandwidth is realized in a network gateway that receives a stream of information formatted for formatted for transmission over a synchronous structured network. The network gateway then terminates the stream of information from the synchronous network to form a stream of packet information for transmission over a second network by encapsulating the information in a framework and removing any non-information (idle) data from the synchronous network stream. The network gateway modifies the stream of frames so that they can be transmitted over the second network and provides transport information to allow the original transmitted stream to be re-created at the network gateway when the packet stream is received for transmission back to the synchronous network facilities.

Various embodiments include a method of optimizing network bandwidth utilization, the method including coupling a first network gateway to a first synchronous-structured network and a packet-formatted network; receiving at the first network gateway a stream of synchronous structured information; modifying the stream of synchronous structured information to remove idle data; converting the modified stream of synchronous structured information to a stream of packets formatted for transmission over the packet-formatted network; transmitting the stream of packets over the packet-formatted network to a second gateway coupled to the packet-formatted network and a second synchronous-structured network; and converting the stream of packets to synchronous-structure formatted information to form a second stream of synchronous-structured information to be transmitted over the second synchronous-structured network.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a high level functional block diagram of a wireless network;

FIG. 2 is a diagram showing a pseudowire encapsulation;

FIG. 3 is a diagram showing a format of optimized transport encapsulation of structure aware synchronous traffic;

FIG. 4A and FIG. 4B is a logic flow diagram describing an optimized transport encapsulation method from the synchronous to packet traffic direction; and

FIG. 5 is a logic flow diagram describing an optimized transport encapsulation method for the packet to synchronous network stream direction.

### DETAILED DESCRIPTION

Network service providers operate a number of synchronous structured networks across the world and these networks are now migrating to packet based infrastructures to interconnect islands of synchronous systems. These networks typically employ dedicated T1/E1 facilities and are used to interconnect businesses, wireless communications systems, and a number of other communications service systems.

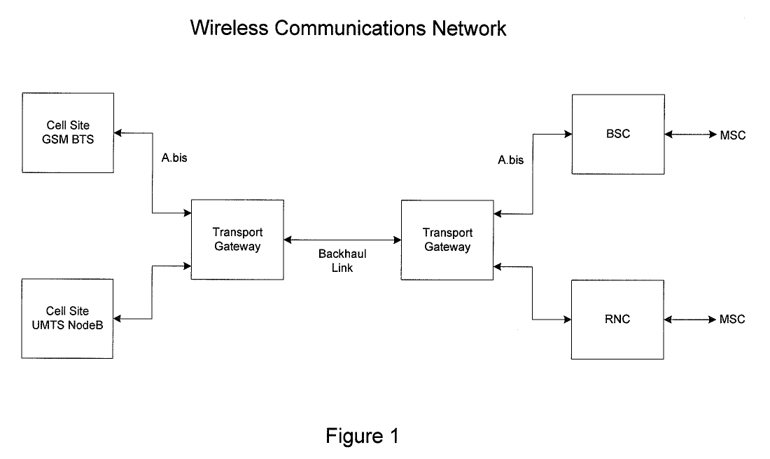

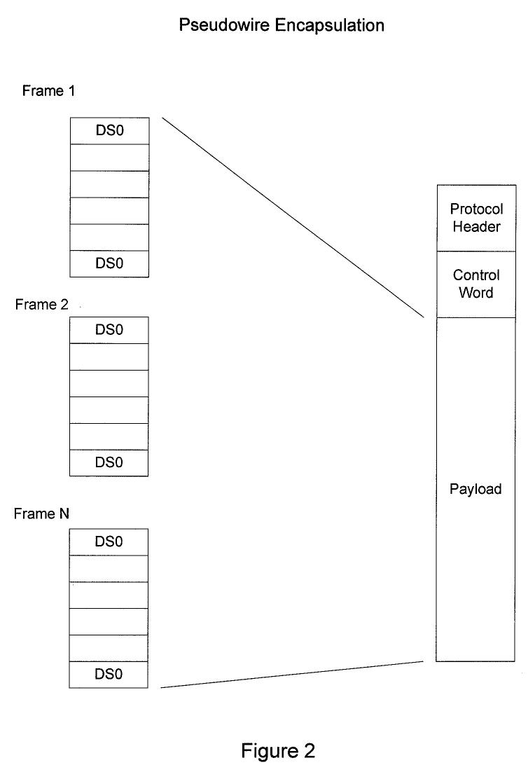

The fundamental issue with classic transport networks is that they do not provide optimized use of bandwidth. With the migration toward a packet infrastructure, the amount of bandwidth being utilized increases with the addition of encapsulation to the basic synchronous structured traffic. As shown in FIG. 1, a wireless communications network that is transported over a packet network infrastructure utilizes a transport gateway for translating the traffic from the synchronous structured traffic format into a packet format. As shown in FIG. 2, the translation of the synchronous structured frame traffic is conducted through the use of packet encapsulation that takes the frames that are received from the structured traffic and places them into packets for transmission over the backhaul link. The encapsulation increases the size of the information that is being transmitted over the packet backhaul link with no gain in the efficiency of the traffic transmission. A portion of the information that is contained in the synchronous structured traffic is idle (non-information) traffic, which, in addition to the encapsulation, results in further loss in the link effective bandwidth.

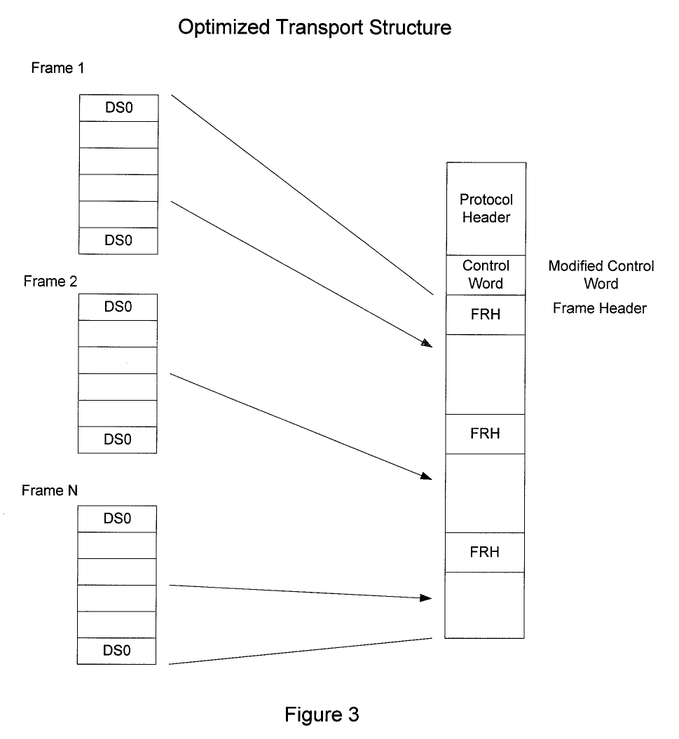

To achieve network efficiencies on the packet backhaul link, the idle information may be removed from the packets that are transported over the backhaul transport link. The removal of the idle information needs to be restored at the far end of the packet backhaul link in order to preserve the essence of the transmitted information content for the original network. As shown in FIG. 3, a Frame header may be added to the payload traffic frames for conveying the idle location information for proper transmit and restoration of the traffic sequence.

In various embodiments, one or more modules for backhaul network implementation may be incorporated into each of the transport gateways that are shown in FIG. 1. The transport gateway modifies the synchronous transport frame information to remove the idle information and transmits the packets containing the frame data to the far-end transport gateway. The far-end transport gateway receives the packets and restores the original frame content, including the idle information for transmission back to a synchronous structured network. This method is designed to preserve the original packet integrity and/or ensure network timing requirements are in compliance.

In some embodiments, the frame modification method shown in FIG. 3 may be implemented in a T1 format. An unmodified frame in the T1 format contains 24 DS0s of information traffic. Each DS0 can contain information or idle data. In order to form the packet for transmission according to various embodiment, each frame is examined for idle information contained within the DS0 traffic. When idle information is discovered in the frame, it is removed and the Frame Header is modified to indicate the idle information. The modified frames (frame header and actual frame data) is delivered to the packet payload for encapsulation in the pseudowire control work and protocol header for transmission to the packet network. Depending on the amount of idle information in the T1 frame, the savings on the in the packet transmission can overcome the amount of overhead included by the frame header and the pseudowire encapsulation. The frame modification format allows the transport provider to transmit the traffic over the backhaul link in an optimal manner from the perspective of network bandwidth usage.

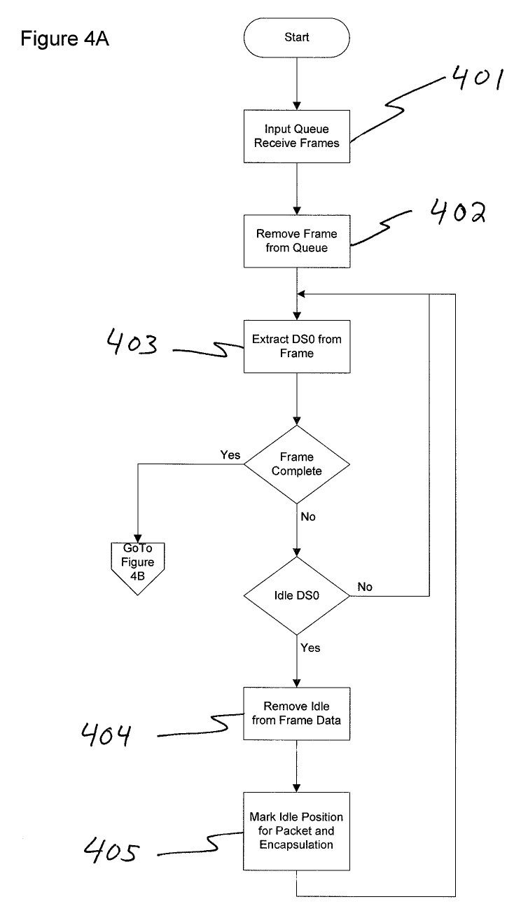

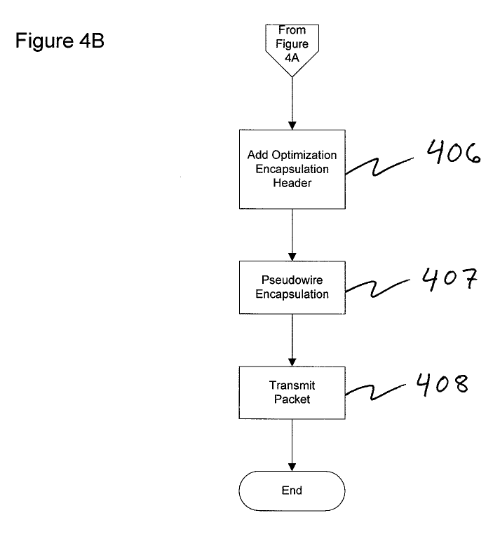

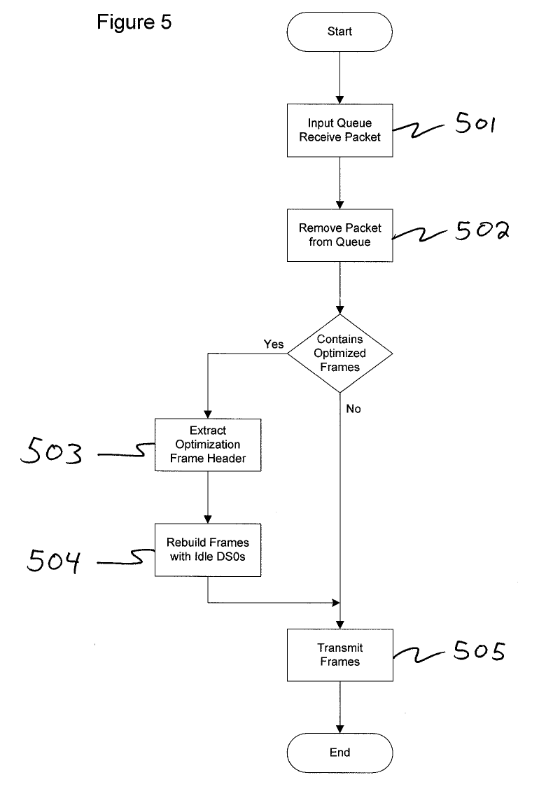

FIGS. 4A, 4B, and 5 together represent the logical flow diagram of the method for modifying and encapsulating the synchronous structured frame data into optimized packets for transmission over the backhaul link. Although various embodiments may be described in the context of a wireless transport network, various embodiments can be implemented in a network that supports multiple protocols that are standards based and/or proprietary. In step 401, frames arrive at the input queue of the synchronous structured interface. In step 402, the frame is removed from the input queue and in step 403, the DS0s are extracted for processing. If the frame is complete, the processing will move to the transmission stage in FIG. 4B. If the frame processing is not complete, the DS0 will be checked for containing idle information. In step 404, the idle will be removed from the frame data block and in step 405 the frame header will be updated to mark the idle position in the frame and packet encapsulation. Once all the DS0s in the frame are processed, the Optimization Encapsulation header (frame header) is added to the frame data and the frame data with header is placed into the packet buffer (step 406). When all of the frames for the packet buffer are processed, the pseudowire encapsulation (control word) is added to the packet payload in step 407 and the packet is transmitted to the packet backhaul link (step 408).

In FIG. 5, as packets are received on the packet backhaul link, they are placed into the input queue for the receive packet buffers (step 501). In step 502, the frame is removed from the packet queue and the control word is checked to determine if the frame contains optimized frames. In step 503, if optimized frames were determined to be in the packet, then the Optimization header is extracted for the frame and in step 504, the frame is re-build with the Idle information re-inserted in the designated DSO timeslots. In step 505, the complete frame is transmitted to the synchronous structured network. When the entire synchronous frame contains idle information, the only information that needs to be transmitted on the backhaul link will be either the optimization header (frame header) or the control word designating the idle traffic condition.

Although various embodiments of the method and system of the present invention have been illustrated in the accompanying Drawings and described in the foregoing Detailed Description, it will be understood that the invention is not limited to the embodiments disclosed, but is capable of numerous rearrangements, modifications, and substitutions without departing from the spirit of the invention as set forth herein.

What is claimed is:

1. A method of optimizing network bandwidth utilization, comprising:
coupling a first network gateway to a first synchronous-structured network and a packet-formatted network;
receiving at the first network gateway a stream of synchronous structured information;
modifying the stream of synchronous structured information to remove idle data;
converting the modified stream of synchronous structured information to a stream of packets formatted for transmission over the packet-formatted network;
transmitting the stream of packets over the packet-formatted network to a second gateway coupled to the packet-formatted network and a second synchronous-structured network; and
converting the stream of packets to synchronous-structure formatted information to form a second stream of synchronous-structured information to be transmitted over the second synchronous-structured network.

2. The method of claim 1, wherein transmitting the stream of packets over the packet-formatted network with the idle data removed uses less bandwidth than transmitting the stream of packets with the idle data.
